(19) United States
(12) Patent Application Publication
(10) Pub. No.: US 2026/0368987 A1
(43) Pub. Date: Nov. 19, 2026

(54) AI ANIMATED DIGITAL HUMAN DEVICE AND METHOD FOR ACHIEVING FACE-TO-FACE COMMUNICATION WITH USERS

(71) Applicant: Beijing Yuedongshuangcheng Technology Co., Ltd., Beijing (CN)

(72) Inventors: Chengying LIU, Beijing (CN); Guoguang LIU, Beijing (CN); Zheng WANG, Beijing (CN); Xu HE, Beijing (CN)

(21) Appl. No.: 19/661,220

(22) Filed: Apr. 28, 2026

(30) Foreign Application Priority Data
May 16, 2025 (CN) 202510635354.1

(51) Int. Cl. G06T 13/40; G06F 3/01; G06V 40/16; H04N 23/611

(52) U.S. Cl. CPC G06T 13/40; G06F 3/011; G06V 40/168; H04N 23/611

(57) ABSTRACT

The present application discloses an AI animated digital human device and method for achieving face-to-face communication with users. By integrating sound localization, infrared laser ranging and facial recognition technologies, the device successfully solves the problem of lack of naturalness and immersion in interactions between a virtual digital human and users. Through a microphone unit and an infrared laser ranging sensor, the device can accurately locate the sound source and measure the distance between an object and a display screen, overcoming the limitation of traditional voice recognition technologies susceptible to environmental noise interference. By incorporating the YOLO algorithm and the FaceNet deep learning model, the device can recognize the user's facial features in real time and precisely locate the eye positions. When the user moves, the device calculates the user's precise physical position and adjusts the orientation of the digital human’s eyes.

### CROSS-REFERENCE TO RELATED APPLICATIONS

The present application claims priority to Chinese Patent Application No. 202510635354.1, filed on May 16, 2025, the entire disclosure of which is incorporated herein by reference.

### TECHNICAL FIELD

The present application relates to the technical field of AI animated digital humans, and in particular to an AI animated digital human device and method for achieving face-to-face communication with users.

### BACKGROUND

With the rapid development of artificial intelligence technology, the application of virtual characters and human-computer interaction devices is becoming increasingly widespread. In many fields, how to enable virtual digital humans to interact with users in a more natural and realistic manner has become an urgent technical challenge to be solved.

In the existing technology, although some virtual human interaction devices can perform user positioning through voice recognition and image processing techniques, most devices can only provide a limited interactive experience.

Therefore, how to enable virtual digital humans to communicate with users more naturally and smoothly and enhance immersion and realism has become an urgent problem to be solved.

### SUMMARY

The present application provides an AI animated digital human device and method for achieving face-to-face communication with users, aiming to further enhance the immersion and sense of reality of interaction between the user and the virtual digital human.

In a first aspect, an AI animated digital human device for achieving face-to-face communication with users, comprising:
a display screen, which is used to present an AI animated digital human;
a plurality of microphone units distributed based on the display screen, which are used to independently collect voice information of a user near the display screen;
a plurality of distance measuring sensors distributed based on the display screen, which are used to respectively measure the distance between the sensors and the user;
a plurality of cameras distributed based on the display screen and used to acquire facial information of the user;
a sound source positioning module, which is used to determine the sound source position based on the voice information collected by the plurality of microphone units and the distances between the plurality of distance measuring sensors and the user;
a visual tracking module, which is used to determine one camera closest to the current sound source among the plurality of cameras, control the camera to capture the user's facial image, and detect and obtain facial feature information based on the user's facial image; perform subsequent face matching and tracking based on the facial feature information, and control the AI animated digital human to move within the display screen following changes in the user's actual position, so that the AI animated digital human maintains a face-to-face orientation with the user.

In the above-mentioned solution, optionally, the display screen is an arc-shaped cylinder.

In the above-mentioned solution, optionally, the cross-section of the display screen is semicircular.

In the above-mentioned solution, optionally, the plurality of microphone units correspond to the distance measuring sensors one to one, and each microphone unit and the corresponding distance measuring sensor thereof are integrated into a whole.

In the above-mentioned solution, optionally, the plurality of microphone units are respectively installed on an upper frame, a lower frame, a left frame and a right frame of the display screen.

In the above-mentioned solution, optionally, a plurality of microphone units are located on the upper frame of the display screen, and a plurality of microphone units are located on the lower frame of the display screen, with equal numbers; a plurality of microphone units are located on the left frame of the display screen, and a plurality of microphone units are located on the right frame of the display screen, with equal numbers.

In the above-mentioned solution, optionally, the plurality of cameras are installed on the upper frame of the display screen.

In the above-mentioned solution, optionally, all microphone units located on the upper frame of the display screen are divided into several groups with equal number, and the plurality of cameras are respectively distributed at intervals between adjacent groups of microphone units.

In the above-mentioned solution, optionally, the subsequent face matching and tracking based on the facial feature information comprises the following steps: further determining the coordinate positions of the user's eyes according to the facial features, and using a ray casting algorithm simulating mouse picking of a three-dimensional virtual simulation model object to control the AI animated digital human to maintain not only a face-to-face state with the user but also an eye-to-eye line alignment.

In a second aspect, a method for controlling the facial orientation of the virtual digital human on the display screen, comprising the following steps:

Step 1: Acquire sound source signals received by the plurality of microphones in a microphone array, and measure the time differences of arrival (TDOA) of the signals received by the microphones using a TDOA algorithm;

Step 2: Calculate the distance differences between the sound source and the receivers in the microphone array based on the time differences;

Step 3: Based on the measured distance differences and the measured time differences among the plurality of receivers, solve the three-dimensional coordinates of the sound source using a least squares method or Chan algorithm;

Step 4: Measure the physical distance between the object and the display screen using an infrared laser ranging sensor, and calculate the relative position of the user;

Step 5: Acquire a facial image captured by the camera closest to the user based on the relative position of the user, and perform face detection on the image using the YOLO algorithm to extract facial feature points of the user;

Step 6: Based on the extracted facial feature points, generate a facial feature embedding vector of the user using a deep learning model, and calculate the coordinate positions of the user's eyes;

Step 7: Fuse the sound source coordinates from Step 3, the distance data from Step 4 and the facial coordinate data from Step 6, and map these data to the physical position of the display screen using a coordinate transformation algorithm;

Step 8: Based on the mapped physical position, adjust the eye orientation of the virtual digital human using a simulated mouse control algorithm via the control module to maintain eye contact with the user;

Step 9: If the user's position changes, repeat the above steps for real-time updates to ensure that the virtual digital human's eyes always remain aligned with the user's eyes.

Compared with the prior art, the present application has at least the following beneficial effects:

Based on further analysis and research of the problems in the prior art, the present application recognizes the lack of a device that can simultaneously process sound and visual information and adjust the digital human's eye contact in real time, resulting in a rigid and monotonous user interaction experience. By integrating sound localization, infrared laser ranging and facial recognition technologies, the device successfully solves the problem of lack of naturalness and immersion in interactions between virtual digital humans and users in the background art. Through the microphone array and the infrared laser ranging sensors, the device can accurately locate the sound source and measure the distance between an object and the display screen, overcoming the limitation of traditional voice recognition technologies susceptible to environmental noise interference. By incorporating the YOLO algorithm and the FaceNet deep learning model, the device can recognize the user's facial features in real time and precisely locate the eye positions, thereby achieving synchronized eye contact between the digital human's eyes and the user's eyes. When the user moves, the device calculates the user's precise physical position and adjusts the orientation of the digital human's eyes, ensuring that the digital human always maintains a face-to-face state with the user. In this way, the virtual digital human can not only provide higher interaction accuracy but also operate stably in various environments, avoiding the problems of misaligned eyes and rigid interaction of virtual digital humans in the background art, and greatly enhancing the user's immersion and interaction experience. Overall, the technical solution of the present invention can achieve more natural and realistic interaction between the virtual human and the user, addressing multiple shortcomings in the prior art and improving the effectiveness and practicality of intelligent human-computer interaction.

### BRIEF DESCRIPTION OF THE DRAWINGS

FIG. 1 is a diagram of the AI animated digital human device for achieving face-to-face communication with users according to one embodiment of the present application; the figure shows an AI-generated digital human image.

### DETAILED DESCRIPTION OF THE EMBODIMENTS

In order to clearly understand the objectives, technical solutions and advantages of the present application, the present application is further described in detail below with reference to the drawings and embodiments. It should be understood that the embodiments described herein are only for the purpose of explaining the present application and are not intended to limit the present application.

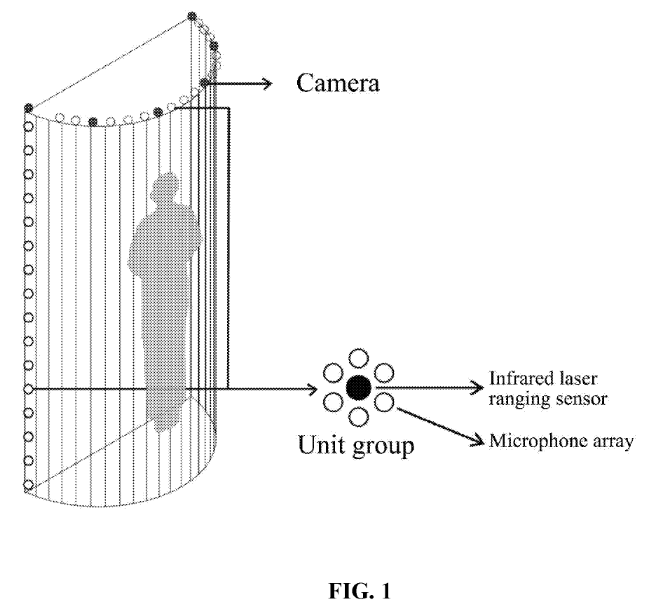

In one embodiment, as shown in FIG. 1, an AI animated digital human device for achieving face-to-face communication with users is provided, comprising:
a display screen, which is used to present an AI animated digital human;
a plurality of microphone units distributed based on the display screen, which are used to independently collect voice information of a user near the display screen; the plurality of microphone units distributed based on the display screen should be understood in a broad sense, for example, the microphone units may be evenly distributed around the display screen, arranged around the display screen in a predetermined manner, or arranged on two sides or at the top and bottom of the display screen in a predetermined manner, which is not specifically limited in this embodiment;
a plurality of distance measuring sensors distributed based on the display screen, which are used to respectively measure the distance between the sensors and the user; the plurality of distance measuring sensors distributed based on the display screen should be understood in a broad sense, for example, the distance measuring sensors may be evenly distributed around the display screen, arranged around the display screen in a predetermined manner, or arranged on two sides or at the top and bottom of the display screen in a predetermined manner, which is not specifically limited in this embodiment;
a plurality of cameras distributed based on the display screen and used to acquire facial information of the user;
the plurality of cameras distributed based on the display screen should be understood in a broad sense, for example, the cameras may be evenly distributed around the display screen, arranged around the display screen in a predetermined manner, or arranged on two sides or at the top and bottom of the display screen in a predetermined manner, which is not specifically limited in this embodiment;
a sound source positioning module, which is used to determine the sound source position based on the voice information collected by the plurality of microphone units and the distances between the plurality of distance measuring sensors and the user; the user here refers to the current speaker who is communicating with the AI animated digital human.
a visual tracking module, which is used to determine one camera closest to the current sound source among the plurality of cameras, control the camera to capture the user's facial image, and detect and obtain facial feature information based on the user's facial image; perform subsequent face matching and tracking based on the facial feature information, and control the AI animated digital human to move within the display screen following changes in the user's actual position, so that the AI animated digital human maintains a face-to-face orientation with the user.

In this embodiment, the display screen is an arc-shaped cylinder.

In this embodiment, the cross-section of the display screen is semicircular.

In this embodiment, the plurality of microphone units correspond to the distance measuring sensors one to one, and each microphone unit and the corresponding distance measuring sensor thereof are integrated into a whole.

In this embodiment, the plurality of microphone units are respectively installed on an upper frame, a lower frame, a left frame and a right frame of the display screen.

In this embodiment, a plurality of microphone units are located on the upper frame of the display screen, and a plurality of microphone units are located on the lower frame of the display screen, with equal numbers; a plurality of microphone units are located on the left frame of the display screen, and a plurality of microphone units are located on the right frame of the display screen, with equal numbers.

In this embodiment, the plurality of cameras are installed on the upper frame of the display screen.

In this embodiment, all microphone units located on the upper frame of the display screen are divided into several groups with equal number, and the plurality of cameras are respectively distributed at intervals between adjacent groups of microphone units.

In this embodiment, the subsequent face matching and tracking based on the facial feature information comprises the following steps: further determining the coordinate positions of the user's eyes according to the facial features, and using a ray casting algorithm simulating mouse picking of a three-dimensional virtual simulation model object to control the AI animated digital human to maintain not only a face-to-face state with the user but also an eye-to-eye line alignment.

The microphone array is one of the core components of this embodiment, which accurately locates the sound source using the TDOA algorithm. The microphone array consists of a plurality of microphones installed around the frames of the display screen. The microphones work together and operate synchronously. At each microphone, an infrared laser ranging sensor is arranged for real-time measurement of the physical distance between the object and the screen. The installation of the infrared sensors ensures that accurate distance information between the sound source and the screen can be obtained and provides support for subsequent coordinate calculations.

Through the TDOA algorithm, the microphone array can measure the time differences from the user's voice to each microphone. Based on these time differences, the system calculates the distance differences between the sound source and the microphones using the formula \ (\Delta d = c \cdot \Delta t\), then converts the time differences into position differences through a mathematical model, and ultimately locates the sound source. This process involves solving the time differences among multiple receivers using the least squares method or the Chan algorithm to determine the two-dimensional or three-dimensional coordinates of the sound source.

Capture the user's facial image using the cameras installed on the display screen. Use the YOLO (You Only Look Once) algorithm for face detection, and extract the user's facial feature points from the image. Generate the user's embedding vectors, which contain the user's unique facial features, using the deep learning model FaceNet. In this way, the system can accurately recognize and locate the user's facial features, especially the position of the eyes, providing a basis for adjusting the orientation of the digital human's eyes.

The control module fuses the sound source position obtained by the TDOA algorithm, the physical distance data measured by the infrared laser ranging sensors and the user's facial features extracted by the facial recognition module to calculate the user's precise physical position relative to the screen. Then, based on these data, the control module uses a coordinate transformation algorithm to map the user's position to the physical coordinates of the display screen. Next, according to the mapped physical position, the control module uses a simulated mouse control algorithm to adjust the eye orientation of the virtual digital human, so that the virtual digital human makes eye contact with the user, ensuring a face-to-face communication effect.

As the user moves, the microphone array and the cameras capture the user's positional changes in real time and dynamically adjust them through the aforementioned algorithms. The virtual digital human's eyes are synchronously adjusted with the user's positional changes, thereby always maintaining a face-to-face state. This function enables the virtual digital human to interact with the user naturally and smoothly from different angles and distances.

This embodiment successfully solves the problems of monotonous virtual digital human interaction experience and lack of sense of reality in the prior art, especially the natural interaction effect in face-to-face communication scenarios, through the comprehensive use of sound localization, infrared laser ranging and facial recognition technologies.

Using the microphone array and the infrared laser ranging sensors, the system can accurately measure the distance between the sound source and the display screen, thereby ensuring that the digital human can correctly locate the user's position. This technology effectively overcomes the interference of environmental noise on positioning accuracy in traditional voice recognition technologies and can operate stably under different environmental conditions, providing higher interaction accuracy.

Using the YOLO algorithm and the FaceNet deep learning model, the system can detect and recognize the user's facial features in real time, especially the position of the eyes. This technology improves the accuracy and real-time performance of face recognition, and avoids the recognition failures of traditional face recognition technologies in low-light environments or when the angle is not correct. Furthermore, by combining face recognition with sound localization, the system can accurately track the user at different positions and angles.

Through the above technologies, the interaction between the virtual digital human and the user becomes more vivid and natural, effectively eliminating the rigidity and unnaturalness in traditional virtual human interactions, and enhancing the user's immersion. During face-to-face communication, the user can feel the digital human's gaze and response, greatly improving the sense of reality of the virtual interaction. Especially in scenarios requiring high interactivity, the system can provide an experience that better aligns with human communication habits. By combining multiple technologies, the system can obtain real-time changes in the user's position and make adjustments, offering strong adaptability. Regardless of the user's position or angle, the virtual digital human can adjust the orientation of its eyes at any time, thereby ensuring that the digital human always maintains a face-to-face state with the user. Furthermore, strong real-time performance enables the system to operate stably in dynamic environments, making it suitable for various application scenarios with high real-time requirements, such as intelligent customer service, virtual assistants, etc.

This embodiment combines sound localization, infrared ranging and facial recognition technologies to provide a high-precision, high-real-time virtual digital human interaction solution. It not only solves the problems mentioned in the background but also greatly enhances the interaction naturalness and immersion of the virtual digital human, providing a new technical path for the further development of the field of intelligent man-machine interaction.

In an embodiment, a method for controlling the facial orientation of the virtual digital human on the display screen is provided, characterized by comprising the following steps:

Step 1: Acquire sound source signals received by the plurality of microphones in a microphone array, and measure the time differences of arrival (TDOA) of the signals received by the microphones using a TDOA algorithm;

Step 2: Calculate the distance differences between the sound source and the receivers in the microphone array based on the time differences;

Step 3: Based on the measured distance differences and the measured time differences among the plurality of receivers, solve the three-dimensional coordinates of the sound source using the least squares method or the Chan algorithm;

Step 4: Measure the physical distance between the object and the display screen using an infrared laser ranging sensor, and calculate the relative position of the user;

Step 5: Based on the relative position of the user, acquire a facial image captured by the camera closest to the user, perform face detection on the image using the YOLO algorithm, and extract facial feature points of the user;

Step 6: Based on the extracted facial feature points, generate a facial feature embedding vector of the user using a deep learning model, and calculate the coordinate positions of the user's eyes;

Step 7: Fuse the sound source coordinates from Step 3, the distance data from Step 4 and the facial coordinate data from Step 6, and map these data to the physical position of the display screen using a coordinate transformation algorithm;

Step 8: Based on the mapped physical position, adjust the eye orientation of the virtual digital human using a simulated mouse control algorithm via the control module to maintain eye contact with the user;

Step 9: If the user's position changes, repeat the above steps for real-time updates to ensure that the virtual digital human's eyes always remain aligned with the user's eyes.

This embodiment describes the process of controlling the eye orientation of the virtual digital human through multiple steps. First, measure the time differences of the sound signal arriving at the microphones by the microphone array, and calculate the position of the sound source using the TDOA algorithm. Next, the system obtains the physical distance between the user and the screen through the infrared laser ranging sensors, simultaneously performs face detection through the cameras, and extracts the user's facial feature points using the FaceNet model. The control module combines this information, maps the user's position to the physical coordinates of the display screen through coordinate transformation, and finally adjusts the eye orientation of the virtual digital human using the simulated mouse control algorithm.

This embodiment can achieve the complete process from sound localization and facial recognition to eye orientation adjustment, ensuring that the virtual digital human can respond to the user's positional changes in real time and interact naturally and smoothly. Through precise facial feature extraction and multi-sensor data fusion, the system can greatly improve the accuracy of the virtual digital human and the quality of the interaction experience.

In one embodiment, an AI animated digital human device that uses sound localization and facial tracking to achieve face-to-face communication with users is provided, as shown in FIG. 1:
hollow circles represent microphone devices with infrared ranging function;
solid circles represent miniature cameras installed vertically on the outward side of the screen;
the semi-arc portion represents a flexible LED screen device, and the character inside is a virtual simulation three-dimensional digital human;

Units of the microphone array are installed on the upper, lower, left and right frames of the screen at equal spacing. One infrared laser ranging sensor is installed at each microphone.

When a person approaches, the infrared laser ranging array detects the nearby object. For example, if five sets of infrared laser sensors simultaneously detect the distance to the object, an array of different distances a1, a2, a3, a4 and a5 is formed.

Anti-noise design: Beamforming algorithm is combined with an RNNoise noise reduction module.

When a person approaches and speaks, the microphone array locates the sound source based on the TDOA algorithm, while locating the physical position of the sound source, i.e., the mouth, based on the values measured by the distance measuring points from the speaker to the curved screen.

Visual tracking: Based on the determined physical position, find the camera currently closest to that direction. Perform face detection on the user using the camera. Use a face detection algorithm (the deep learning-based YOLO algorithm) on the camera image to detect the face. Obtain the position, size and feature points of each face. Based on facial features, determine the eye position coordinates (x, y) of the current speaker.

Extract features on the detected face and record them in a database. Use a deep learning model (FaceNet) to generate face embedding vectors. The embedding vectors can be used for subsequent face matching and tracking.

Convert the installation position of the current camera to a physical position with the screen as a reference by coordinate transformation.

Based on the newly calculated physical position, use a ray casting algorithm, simulating mouse picking of a three-dimensional virtual simulation model object to control the orientation of the digital human on the screen, so that the line of sight between the digital human eyes and the speaker's eyes in the physical world is aligned.

The speaker can have a face-to-face conversation with the digital human on the screen, and the digital human moves synchronously as the speaker moves continuously, always maintaining a face-to-face orientation.

If the speaker does not make a sound, the digital human will not respond to that person.

This embodiment first uses sound localization to capture the direction of the speaker, finds the speaker's face by facial recognition, and then uses speaker's eye localization to enable the digital human to speak while looking into the speaker's eyes, truly achieving the purpose of face-to-face communication.

The technical features of the above embodiments can be combined in any way. For the sake of concise description, not all possible combinations of the technical features in the above embodiments are described. However, as long as there is no contradiction in the combination of these technical features, they should be considered within the scope described in the specification.

What is claimed is:

1. An AI animated digital human device for achieving face-to-face communication with users, comprising:
a display screen, which is used to present an AI animated digital human;
a plurality of microphone units distributed based on the display screen, which are used to independently collect voice information of a user near the display screen;
a plurality of distance measuring sensors distributed based on the display screen, which are used to respectively measure the distance between the sensors and the user;
a plurality of cameras distributed based on the display screen and used to acquire facial information of the user;
a sound source positioning module, which is used to determine the sound source position based on the voice information collected by the plurality of microphone units and the distances between the plurality of distance measuring sensors and the user;
a visual tracking module, which is used to determine one camera closest to the current sound source among the plurality of cameras, control the camera to capture the user's facial image, and detect and obtain facial feature information based on the user's facial image; perform subsequent face matching and tracking based on the facial feature information, and control the AI animated digital human to move within the display screen following changes in the user's actual position, so that the AI animated digital human maintains a face-to-face orientation with the user.

2. The device according to claim 1, wherein the display screen is an arc-shaped cylinder.

3. The device according to claim 1, wherein the cross-section of the display screen is semicircular.

4. The device according to claim 1, wherein the plurality of microphone units correspond to the distance measuring sensors one to one, and each microphone unit and the corresponding distance measuring sensor thereof are integrated into a whole.

5. The device according to claim 1, wherein the plurality of microphone units are respectively installed on an upper frame, a lower frame, a left frame and a right frame of the display screen.

6. The device according to claim 5, wherein a plurality of microphone units are located on the upper frame of the display screen, and a plurality of microphone units are located on the lower frame of the display screen, with equal numbers; a plurality of microphone units are located on the left frame of the display screen, and a plurality of microphone units are located on the right frame of the display screen, with equal numbers.

7. The device according to claim 6, wherein the plurality of cameras are installed on the upper frame of the display screen.

8. The device according to claim 6, wherein all microphone units located on the upper frame of the display screen are divided into several groups of equal number, and the plurality of cameras are respectively distributed at intervals between adjacent groups of microphone units.

9. The device according to claim 1, wherein the subsequent face matching and tracking based on the facial feature information comprises: further determining the coordinate positions of the user's eyes according to the facial features, and using a ray casting algorithm simulating mouse picking of a three-dimensional virtual simulation model object to control the AI animated digital human to maintain not only a face-to-face state with the user but also an eye-to-eye line alignment.

10. A method for controlling the facial orientation of the virtual digital human on the display screen, comprising the following steps:
Step 1: Acquire sound source signals received by the plurality of microphones in a microphone array, and measure the time differences of arrival (TDOA) of the signals received by the microphones using a TDOA algorithm;
Step 2: Calculate the distance differences between the sound source and the receivers in the microphone array based on the time differences;
Step 3: Based on the measured distance differences and the measured time differences among the plurality of receivers, solve the three-dimensional coordinates of the sound source using the least squares method or the Chan algorithm;
Step 4: Measure the physical distance between the object and the display screen using an infrared laser ranging sensor, and calculate the relative position of the user;
Step 5: Based on the relative position of the user, acquire a facial image captured by the camera closest to the user, perform face detection on the image using the YOLO algorithm, and extract facial feature points of the user;
Step 6: Based on the extracted facial feature points, generate a facial feature embedding vector of the user using a deep learning model, and calculate the coordinate positions of the user's eyes;
Step 7: Fuse the sound source coordinates from Step 3, the distance data from Step 4, and the facial coordinate data from Step 6, and map these data to the physical position of the display screen using a coordinate transformation algorithm;
Step 8: Based on the mapped physical position, adjust the eye orientation of the virtual digital human using a simulated mouse control algorithm via the control module to maintain eye contact with the user;
Step 9: If the user's position changes, repeat the above steps for real-time updates to ensure that the virtual digital human's eyes always remain aligned with the user's eyes.
